(19) United States
(12) Patent Application Publication
(10) Pub. No.: US 2009/0153550 A1
(43) Pub. Date: Jun. 18, 2009

(54) Virtual object rendering system and method

(75) Inventors: Stephen Keaney, Longmeadow, MA (US); Michael Gay, Collinsville, CT (US); Michael Zigmont, Kensington, CT (US); Anthony Bailey, Wallingford, CT (US); Dave Casamona, Plantsville, CT (US); Aaron Thiel, Durham, CT (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/002,900

(22) Filed: Dec. 18, 2007

(51) Int. Cl. G06T 15/00

(52) U.S. Cl. 345/419

(57) ABSTRACT

There is provided a virtual object rendering system comprising a camera, at least one sensor for sensing perspective data corresponding to a camera perspective, a communication interface configured to send the perspective data to a virtual object rendering computer, and the virtual object rendering computer having one or more virtual objects, the virtual object rendering computer configured to determine the camera perspective from the perspective data, and to perform the virtual object rendering by redrawing the one or more virtual objects to align the one or more virtual objects with the camera perspective. The virtual object rendering computer may be further configured to produce a merged image of the one or more redrawn virtual objects and a camera image received from the camera.

### BACKGROUND OF THE INVENTION

1. Field of the Invention

The present invention is generally in the field of videography. More particularly, the present invention is in the field of special effects and virtual reality.

2. Background Art

The art and science of videography strives to deliver the most expressive and stimulating visual experience possible for its viewers. However, that pursuit of a creative ideal must be reconciled with the practical constraints associated with video production, which can vary considerably from one type of production content to another. As a result, some scenes that a videographer may envision and wish to include in a video presentation, might, because of practical limitations, never be given full artistic embodiment. Consequently, highly evocative, and aesthetically desirable components of a video presentation may be provided in a suboptimal format, or omitted entirely, due to physical space limitations and/or budget constraints.

Television sports and news productions, for example, may rely heavily on the technical capabilities of a studio set to support and assure the production standards of a sports or news video presentation. A studio set often provides optimal lighting, audio transmission, sound effects, announcer cueing, screen overlays, and production crew support, in addition to other technical advantages. The studio set, however, typically provides a relatively fixed spatial format and therefore may not be able to accommodate over-sized, numerous, or dynamically interactive objects without significant modification, making the filming of those objects in studio, costly and perhaps logistically prohibitive.

In a conventional approach to overcoming the challenge of including video footage of very large, cumbersome, or moving objects in studio set based video productions, those objects may be videotaped on location, as an alternative to filming them in studio. For example, large or moving objects may be shot remotely, and integrated with a studio based presentation by means of video monitors included on the studio set for program viewers to observe, perhaps accompanied by commentary from an on stage anchor or analyst. Unfortunately, this conventional solution requires sacrifice of some of the technical advantages that the studio setting provides, without necessarily avoiding significant production costs due to the resources required to transport personnel and equipment into the field to support the remote filming. Furthermore, the filming of large or cumbersome objects on location may still be complicated because their unwieldiness may make it difficult for them to be moved smoothly or to be readily manipulated to provide an optimal viewer perspective.

Another conventional approach to overcoming the obstacles to filming physically unwieldy objects makes use of general advances in computing and processing power, which have made rendering virtual objects an alternative to filming live objects that are difficult to capture. Although this alternative may help control production costs, there are drawbacks associated with conventional approaches to rendering virtual objects. One significant drawback is that the virtual objects rendered according to conventional approaches may not appear lifelike or sufficiently real to a viewer. That particular inadequacy can create an even greater reality gap for a viewer when the virtual object is applied to live footage as a substitute for a real object, in an attempt to simulate events involving the object.

Accordingly, there is a need to overcome the drawbacks and deficiencies in the art by providing a solution for rendering a virtual object having an enhanced realism, such that blending of that virtual object with real video footage presents a viewer with a pleasing and convincing simulation of real or imagined events.

### SUMMARY OF THE INVENTION

A virtual object rendering system and method, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of an exemplary virtual object rendering system including a jib mounted camera, in accordance with one embodiment of the present invention;

FIG. 2 shows a functional block diagram of the exemplary virtual object rendering system shown in FIG. 1;

FIG. 3 shows a flowchart describing the steps, according to one embodiment of the present invention, of a method for rendering one or more virtual objects;

FIG. 4A shows an exemplary video signal before implementation of an embodiment of the present invention; and

FIG. 4B shows an exemplary merged image combining the video signal of FIG. 4A with redrawn virtual objects rendered according to one embodiment of the present invention.

### DETAILED DESCRIPTION OF THE INVENTION

The present application is directed to a virtual object rendering system and method. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

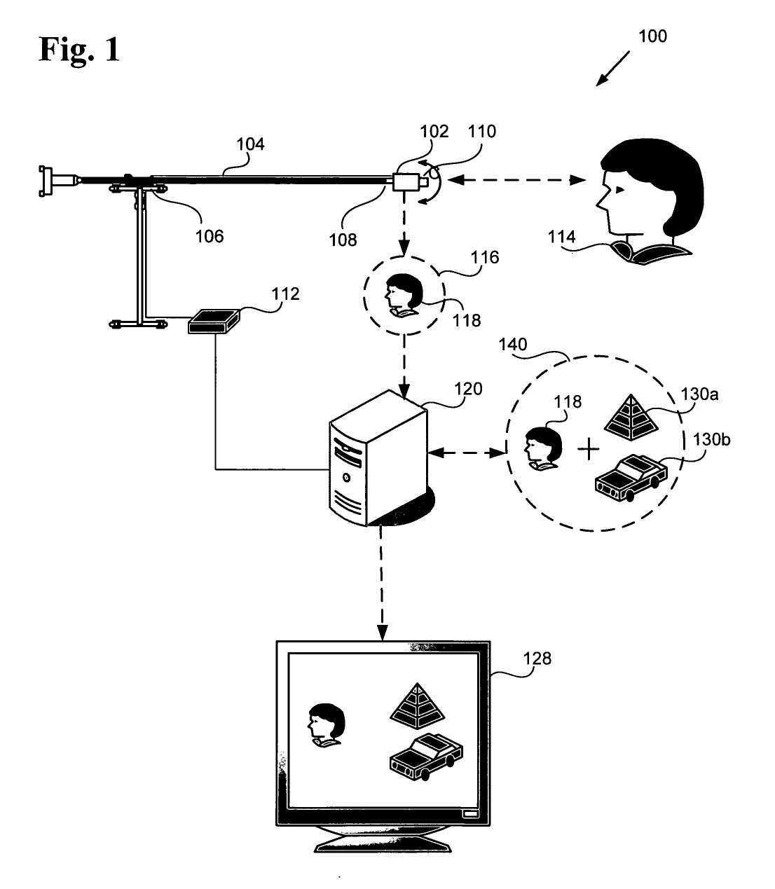

FIG. 1 presents a diagram of exemplary virtual object rendering system 100, in accordance with one embodiment of the present invention. Virtual object rendering system 100 includes camera 102, which may be a high definition (HD) video camera, for example, camera mount 104, axis sensor 106, tilt sensor 108, zoom sensor 110, communication interface 112, and virtual object rendering computer 120. In FIG. 1, virtual object rendering system 100 is shown in combination with live object 114 and video display 128. Also shown in FIG. 1 are video signal 116 including camera image 118, and merged image 140 including camera image 118 merged with redrawn virtual objects 130a and 130b.

Although in the embodiment of FIG. 1, camera 102 is shown as a video camera mounted on camera mount 104, which may be a jib, for example, in another embodiment virtual object rendering system may be implemented without camera mount 104, while camera 102 may be another type of camera, such as a still camera, for example. In embodiments lacking camera mount 104, camera 102 may be positioned, i.e., located and oriented, by any other suitable means, such as by a human camera operator, for example. It is noted that for the purposes of the present application, the term location refers to a point in three dimensional space corresponding to a hypothetical center of mass of camera 102, while the term orientation refers to rotation of camera 102 about three mutually orthogonal spatial axes having their common origin at the location of camera 102. In some embodiments, the location of camera 102 may be fixed, so that sensing a position of camera 102 is equivalent to sensing its orientation, while in other embodiments the orientation of camera 102 may be fixed.

Moreover, although the embodiment of FIG. 1 includes axis sensor 106 and tilt sensor 108 affixed to camera mount 104, in addition to zoom sensor 110 affixed to camera 102, in another embodiment there may be more or fewer sensors for sensing the location, orientation, and zoom of camera 102, which provide perspective data corresponding to the perspective of camera 102. Those more or fewer sensors may sense perspective data as parameters other than axis deflection, tilt, and zoom, as shown in FIG. 1. In one embodiment, virtual object rendering system 100 can be implemented with as few as one sensor capable of sensing all perspective data required to determine the perspective of camera 102. Returning to the embodiment of FIG. 1, camera 102 is mounted on camera mount 104 and positioning of camera 102 can be accomplished by adjusting the axis and tilt of camera mount 104. Adjustments made to the axis and tilt of camera mount 104 are sensed by axis sensor 106 and tilt sensor 108, respectively. Camera mount 104 can be attached to a permanent floor fixture or to a movable base equipped with castors, for example.

In FIG. 1, perspective data corresponding to the perspective of camera 102 is communicated to virtual object rendering computer 120 for determination of the camera perspective. Camera perspective is determined by data from all sensors of virtual object rendering system 100, including axis sensor 106, tilt sensor 108, and zoom sensor 110. Communication interface 112 is coupled to virtual object rendering computer 120 and all recited sensors of virtual object rendering system 100. Communication interface 112 receives the perspective data specifying the location, orientation, and zoom of camera 102 from the sensors of virtual object rendering system 100, and transmits the perspective data to virtual object rendering computer 120.

Virtual object rendering computer 120 is configured to receive the perspective data and calculate a camera perspective of camera 102 corresponding to its location, orientation, and zoom. Virtual object rendering computer 120 can then redraw a virtual object aligned to the perspective of camera 102. As shown in FIG. 1, virtual object rendering computer 120 receives video signal 116 containing camera image 118 of live object 114. In the present embodiment, virtual object rendering computer 120 is further configured to merge one or more redrawn virtual objects with video signal 116. As further shown by merged image 140, in the present embodiment, live image 118 can be merged with redrawn virtual images 130a and 130b.

Redrawing virtual images 130a and 130b to be aligned with the perspective of camera 102 harmonizes the aspect of virtual images 130a and 130b with the aspect of live object 114 captured by camera 102 as camera image 118. Redrawn virtual images 130a and 130b have an enhanced realism due to their correspondence with the perspective of camera 102. Consequently, merged image 140 may provide a more realistic simulation combining camera image 118 and virtual images 130a and 130b. Merged image 140 can be sent as an output signal by virtual image rendering computer 120 to be displayed on video monitor 128 to provide a viewer with a pleasing and visually realistic simulation.

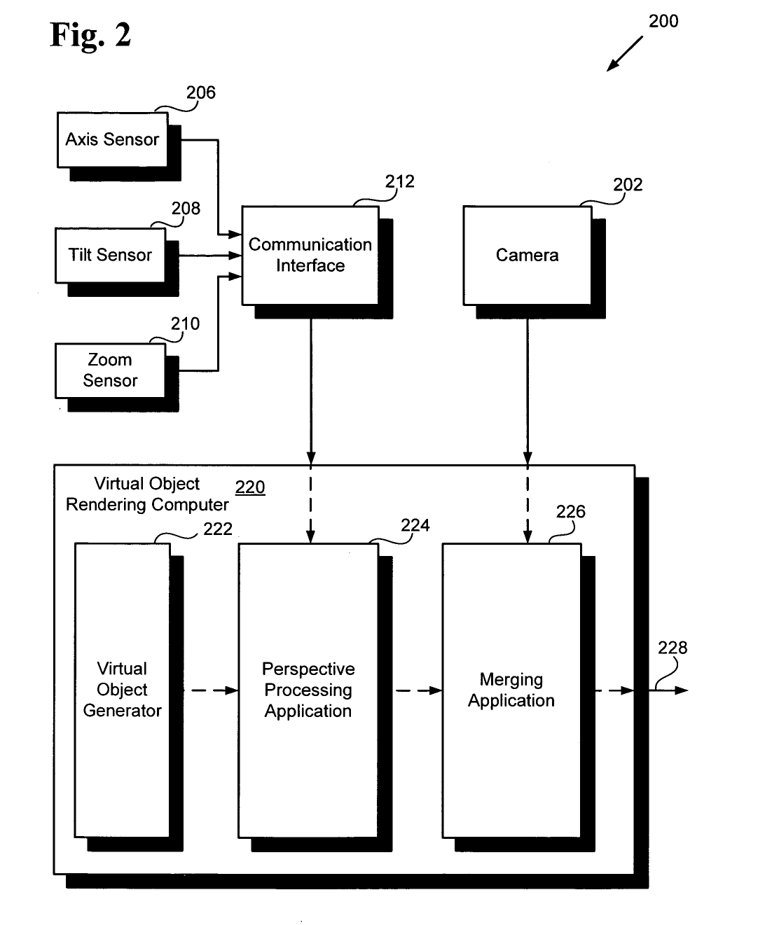

FIG. 2 shows functional block diagram 200 of exemplary virtual object rendering system 100, shown in FIG. 1. Functional block diagram 200 includes camera 202, axis sensor 206, tilt sensor 208, zoom sensor 210, communication interface 212, and virtual object rendering computer 220, corresponding respectively to camera 102, axis sensor 106, tilt sensor 108, zoom sensor 110, communication interface 112, and virtual object rendering computer 120, in FIG. 1. In FIG. 2, virtual object rendering computer 220 is shown to include virtual object generator 222, perspective processing application 224, and merging application 226.

Perspective data corresponding to the perspective of camera 202 is gathered by axis sensor 206, tilt sensor 208, and zoom sensor 210. Communication interface 212 may be configured to receive the perspective data from all recited sensors and to transmit the perspective data to virtual object rendering computer 220. However, communication interface 212 can be configured with internal processing capabilities that may reformat, compress, or recalculate the perspective data before transmission to virtual object rendering computer 220, in order to improve transmission performance or ease the processing burden on virtual object rendering computer 220, for example. Moreover, in one embodiment, computer interface 212 can be an internal component of virtual object rendering computer 220. In that instance, all recited sensors would be coupled to virtual object rendering computer 220 and the perspective data could also be received by rendering computer 220.

In the embodiment of FIG. 2, virtual object rendering computer 220 utilizes perspective processing application 224 to calculate a perspective of camera 202 corresponding to the perspective data provided by axis sensor 206, tilt sensor 208, and zoom sensor 210. Perspective processing application 224 determines a location of camera 202, an orientation of camera 202, and a zoom of camera 202 from the perspective data. Perspective processing application 224 determines the perspective of camera 202 using the position, the orientation, and the zoom data, with or without consideration of additional factors, such as, for example, lighting and distortion, to enhance precision or realism of virtual object rendering.

Virtual object rendering computer 220 utilizes virtual object generator 222 to generate, store and retrieve virtual objects. Virtual object generator 222 is configured to provide one or more virtual objects to perspective processing application 224. Perspective processing application 224 redraws the virtual objects aligned to the perspective of camera 202. It is noted that in one embodiment of the present invention, virtual object generator 222 can be an external component, discrete from virtual object rendering computer 220. Having virtual object generator 222 as an external component may facilitate the use of proprietary virtual objects with virtual object rendering system 100 and may increase performance through a reduced processing burden on virtual object rendering computer 220.

As shown in FIG. 1, virtual object rendering computer 120 may be further configured to merge redrawn virtual objects 130a and 130b with camera image 118. Virtual object rendering computer 120 receives video signal 116 containing camera image 118, from camera 102. Similarly in FIG. 2, a video signal containing a camera image (not shown) is received by virtual object rendering computer 220, from camera 202. The camera image received from camera 202 and the redrawn virtual objects provided by perspective processing application 224 may then be sent to merging application 226 of virtual object rendering computer 220. Virtual object rendering computer 220 utilizes merging application 226 to form a merged image of the camera image from camera 202 and the redrawn virtual objects. The resulting merged image can be sent as output signal 228 from virtual object rendering computer 220.

It is noted that in one embodiment of the present invention, merging application 226 can be an external component, discrete from virtual object rendering computer 220. Having merging application 226 as an external component may facilitate the use of proprietary merging algorithms with virtual object rendering system 100 and may increase performance through a reduced processing burden on virtual object rendering computer 220.

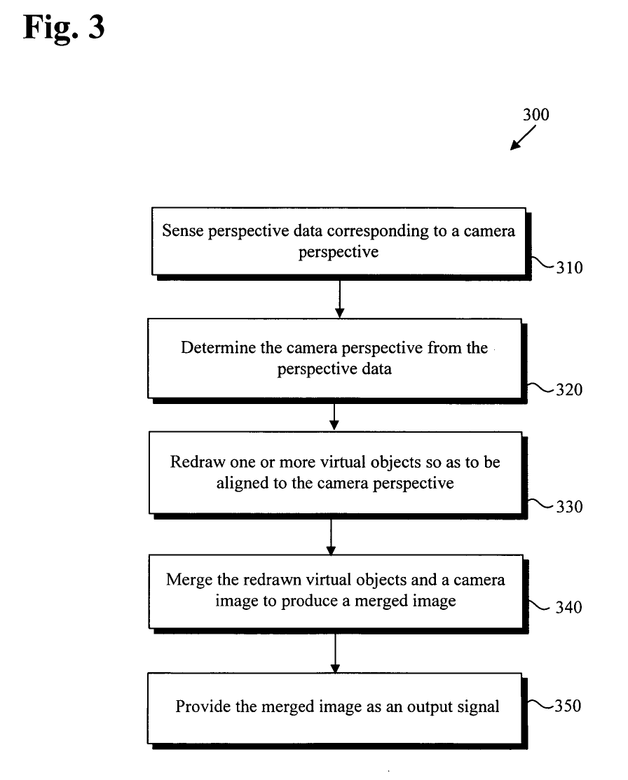

FIG. 3 shows flowchart 300, describing the steps, according to one embodiment of the present invention, of a method for rendering one or more virtual objects. Certain details and features have been left out of flowchart 300 that are apparent to a person of ordinary skill in the art. For example, a step may comprise one or more substeps or may involve specialized equipment or materials, as known in the art. While steps 310 through 350 indicated in flowchart 300 are sufficient to describe one embodiment of the present invention, other embodiments of the invention may utilize steps different from those shown in flowchart 300.

Referring to step 310 of flowchart 300 in FIG. 3 and virtual object rendering system 100 of FIG. 1, step 310 of flowchart 300 comprises sensing perspective data corresponding to a perspective of camera 102. In exemplary virtual object rendering system 100, step 310 is accomplished by axis sensor 106, tilt sensor 108, and zoom sensor 110, which are in communication with virtual object rendering computer 120 through communication interface 112. As discussed in relation to FIG. 1, other embodiments may include additional sensors that sense a location, orientation, and zoom of camera 102 using other parameters, and may sense other factors, such as, for example, lighting and distortion.

Continuing with step 320 of FIG. 3 and functional block diagram 200 of FIG. 2, step 320 of flowchart 300 comprises determining the perspective of camera 202 from the perspective data sensed in step 310. The perspective of camera 202 may be determined through a calculation taking into account perspective data sensed by axis sensor 106, tilt sensor 108, and zoom sensor 110. Determining the camera perspective comprises determining a location and orientation of camera 202, as well as its zoom, and any other parameters that may be used to enhance the precision with which the camera perspective can be calculated. In one embodiment, the determining step includes in its calculation additional factors that are not sensed by axis sensor 206, tilt sensor 208, or zoom sensor 210, but are input to virtual object rendering computer 220 manually. Those additional factors may include lighting and distortion data, for example.

Step 330 of flowchart 300 comprises redrawing one or more virtual objects so as to be aligned to the perspective of camera 202, determined in previous step 320. In the embodiment of FIG. 2, step 330 is performed by perspective processing application 224. As discussed in relation to FIG. 2, perspective processing application 224 receives a virtual object from virtual object generator 222 and redraws the virtual object according to the perspective of camera 202. Although in the present embodiment, virtual object generator 222 is internal to virtual object rendering computer 220, so that virtual object rendering computer generates the virtual object, in another embodiment virtual object generator 222 may be an external component, discrete from virtual object rendering computer 220. In the latter case, virtual object rendering computer 220 would receive the virtual object from external virtual object generator 222. In yet another embodiment, virtual object rendering computer 220 is configured to generate one or more virtual objects as well as to receive one or more virtual objects, so that redrawing the virtual objects may comprise redrawing both generated and received virtual objects.

Continuing with step 340 of flowchart 300, step 340 comprises merging the redrawn virtual objects and a camera image to produce a merged image. Step 340 is shown in the embodiment of FIG. 1 by merged image 140, which is produced by merging camera image 118 and redrawn virtual objects 130a and 130b. Merging a camera image with one or more redrawn virtual objects enables production of a realistic simulation combining live objects and virtual objects.

Step 350 of flowchart 300 comprises providing merged image 140 produced in step 340 as an output signal, as shown by output signal 228 in FIG. 2. Although in the present exemplary method, merged image 140 is provided as an output, in another embodiment of the present method merged image 140 may be stored by virtual object rendering computer 120. It is noted that in one embodiment of the present method, redrawn virtual objects produced in step 330 may be stored by virtual object rendering computer 220 and/or provided as an output signal from virtual object rendering computer 220 prior to merging step 340.

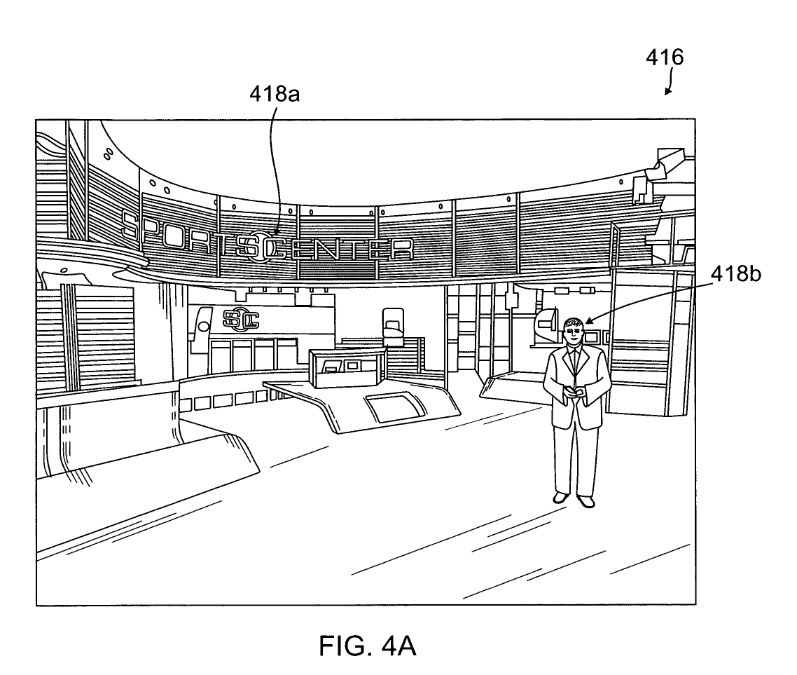

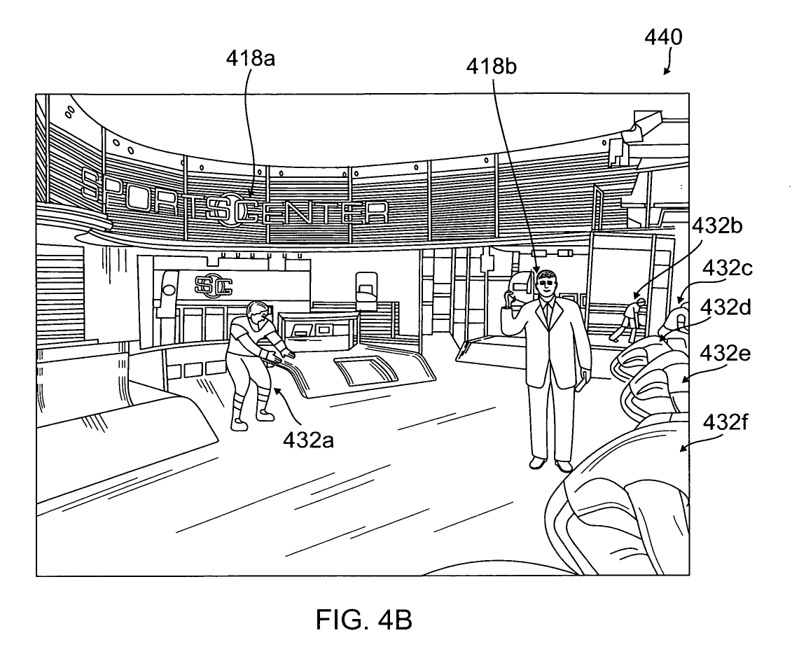

Turning now to FIG. 4A, FIG. 4A shows exemplary video signal 416 before implementation of an embodiment of the present invention. Video signal 416 comprises camera images 418a and 418b recorded by a video camera (not shown in FIG. 4A). Camera images 418a and 418b correspond to live objects (also not shown in FIG. 4A) including a sports broadcast person and a sports news studio set. Video signal 416, camera images 418a and 418b, and their corresponding live objects, correspond respectively to video signal 116, camera image 118, and live object 114, in FIG. 1.

Continuing to FIG. 4B, FIG. 4B shows exemplary merged image 440 combining video signal 416 of FIG. 4A with redrawn virtual objects rendered according to one embodiment of the present invention. Merged image 440 comprises camera images 418a and 418b, merged with redrawn virtual objects 432a through 432f. Redrawn virtual objects 432a through 432f correspond to virtual objects provided by virtual object generator 222, in FIG. 2. Those virtual objects are redrawn by virtual object rendering computer 220 so as to align with the perspective of camera 202, thus harmonizing redrawn virtual objects 432a through 432f with camera images 418a and 418b being filmed by camera 202.

As described in the foregoing, the present application discloses a system and method for rendering virtual objects having enhanced realism. By sensing parameters describing the perspective of a camera, one embodiment of the present invention provides perspective data from which the camera perspective can be determined. By configuring a computer to redraw one or more virtual objects according to the camera perspective, an embodiment of the present invention provides a rendered virtual image having enhanced realism. By further merging the one or more redrawn virtual objects and a camera image of a live object, another embodiment of the present invention enables a viewer to observe a simulation mixing real and virtual imagery in a pleasing and realistic way. In one exemplary implementation the present invention enables a sportscaster broadcasting from a studio to interact with virtual athletes to simulate action in a sporting event. The disclosed embodiments advantageously achieve virtual object rendering that provides an enhanced realism by, for example, allowing a camera to be moved and positioned to desirable perspectives that emphasizing the three-dimensional qualities of a virtual object. The described system and method provide a virtual alternative to having large, cumbersome, or dynamic objects in a studio.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A virtual object rendering system comprising:
a camera;
at least one sensor for sensing perspective data corresponding to a camera perspective;
a communication interface configured to send the perspective data to a virtual object rendering computer; and
the virtual object rendering computer having one or more virtual objects, the virtual object rendering computer configured to determine the camera perspective from the perspective data, and to perform the virtual object rendering by redrawing the one or more virtual objects to align the one or more virtual objects with the camera perspective.

2. The virtual object rendering system of claim 1, wherein the camera comprises a jib mounted camera.

3. The virtual object rendering system of claim 1, wherein the camera comprises a high definition (HD) video camera.

4. The virtual object rendering system of claim 1, wherein a location of the camera is fixed.

5. The virtual object rendering system of claim 1, wherein an orientation of the camera is fixed.

6. The virtual object rendering system of claim 1, wherein the virtual object rendering computer is further configured to generate at least one of the one or more virtual objects.

7. The virtual object rendering system of claim 1, wherein the virtual object rendering computer is further configured to provide the one or more redrawn virtual objects as an output signal.

8. The virtual object rendering system of claim 1, wherein the virtual object rendering computer is further configured to store the one or more redrawn virtual objects.

9. The virtual object rendering system of claim 1, wherein the virtual object rendering computer is further configured to merge the one or more redrawn virtual objects and a camera image received from the camera to produce a merged image.

10. The virtual object rendering system of claim 9, wherein the virtual object rendering computer is further configured to provide the merged image as an output signal.

11. A method for rendering one or more virtual objects, the method comprising:
sensing perspective data corresponding to a camera perspective;
determining the camera perspective from the perspective data; and
redrawing the one or more virtual objects to align the one or more virtual objects with the camera perspective.

12. The method of claim 11, further comprising merging the one or more redrawn virtual objects and a camera image received from the camera to produce a merged image.

13. The method of claim 12, further comprising providing the merged image as an output signal.

14. The method of claim 11, wherein the camera comprises a high definition (HD) video camera.

15. The method of claim 11, wherein the camera comprises a jib mounted camera.

16. The method of claim 15, wherein the sensing is performed by one or more sensors affixed to a jib for the jib mounted camera.

17. The method of claim 11, wherein a location of the camera is fixed.

18. The method of claim 11, wherein an orientation of the camera is fixed.

19. The method of claim 11, further comprising generating the one or more virtual objects.

20. The method of claim 11, further comprising receiving the one or more virtual objects.
